(19) United States
(12) Patent Application Publication
(10) Pub. No.: US 2010/0108147 A1
(43) Pub. Date: May 6, 2010

(54) APPARATUS AND METHOD FOR EXCHANGING FLUID IN A COOLING SYSTEM

(76) Inventor: Victor E. Renard, Kennewick, WA (US)

Correspondence Address: KLARQUIST SPARKMAN, LLP, 121 SW SALMON STREET, SUITE 1600, PORTLAND, OR, 97204, US

(21) Appl. No.: 12/614,261

(22) Filed: Nov. 6, 2009

Related U.S. Application Data
(60) Provisional application No. 61/198,638, filed on Nov. 6, 2008.

(51) Int. Cl. F15D 1/00; F16K 11/10

(52) U.S. Cl. 137/1; 137/625.46

(57) ABSTRACT

A flow control device is configured to facilitate the addition and removal of fluid to and from a cooling system using a rotatable valve member. The rotatable valve member is positioned within an opening in a base member. The rotatable member is movable within the opening between a first position and a second position. When the rotatable member is in the first position, at least two user ports are in fluid communication with one another via at least one passageway of the rotatable member. When the rotatable member is in the second position, two user ports and two external ports are in fluid communication with one another via the at least one passageway of the rotatable member.

### CROSS REFERENCE TO RELATED APPLICATION

This application claims the benefit of U.S. Provisional Application No. 61/198,638, filed on Nov. 6, 2008. The entire disclosure of U.S. Provisional Application No. 61/198,638 is considered to be part of the disclosure of the following application and is hereby incorporated by reference.

### FIELD

This disclosure pertains to an apparatus and method for filling and changing fluid (e.g., coolant) in a non-vented cooling system.

### BACKGROUND

Conventional coolant filling and flushing systems, such as those used to fill and flush automotive type cooling systems, rely on the ability of the coolant system to be opened to the environment by opening a radiator cap and a drain valve to fill and flush the coolant from the system. Such coolant flush and fill systems rely on the radiator cap acting as a vent to remove air that is trapped in the cooling system. Accordingly, there is a need for an apparatus and method for filling and changing coolant that does not require an installed vent in the cooling loop.

### SUMMARY

In one embodiment, a fluid flow control device is configured to facilitate the addition and removal of fluid to and from a cooling system. The cooling system is preferably a non-vented cooling system. The device comprises a base member and a rotatable member. The base member has an opening and plurality of ports capable of being in fluid communication with the opening. The plurality of ports includes at least two user ports and two external ports. The rotatable member has at least one passageway extending therethrough. The rotatable member can be configured to be received in the opening and can be movable within the opening between a first position and a second position. When the rotatable member is in the first position, the two user ports are in fluid communication with one another via the passageway(s) of the rotatable member and the two user ports are not in fluid communication with the external ports. When the rotatable member is in the second position, the two user ports and the two external ports are in fluid communication with one another via the passageway(s) of the rotatable member.

In specific implementations, each of the user ports and each of the external ports have a coupling member associated therewith. The coupling members facilitate the fluid connection of the user ports and external ports with tubing components. In other specific implementations, the coupling members associated with the external ports comprise quick-release coupling members that restrict fluid flow through the coupling members when no tubing components are connected to the quick-release coupling members. The two user ports can be axially aligned with one another, and the two external ports can be axially aligned with one another. Alternatively, the two external ports can be oriented parallel to one another.

In other specific implementations, the rotatable member can include an actuating member for rotating the rotatable member between the first position and the second position. In other specific implementations, the actuating member can be a recessed portion of the rotatable member or an extending portion. A restricting member can be provided to allow rotation of the rotatable member between the first and second positions and restrict rotation of the rotatable member beyond those positions.

In other specific implementations, the rotatable member can include two passageways extending through the rotatable member. In other specific implementations, the passageways can be grooves on opposing sides of the rotatable member. The passageway(s) can also be generally T-shaped, with a first opening portion extending through the rotatable member and a second opening portion extending off of the first opening portion at an angle. Other passageways can be generally L-shaped.

In other specific implementations, the base member can comprise two openings, with each opening being configured to receive a rotatable member and each opening capable of being in fluid communication with one of the user ports and one of the external ports. In other specific implementations, the two user ports can extend from opposite faces of the base member and the two external ports can extend from opposite faces of the base member. If desired, a mounting member can extend from the device. The mounting member can have at least one aperture for securing the device to another structural element. If desired, a bracket can be secured to the base member to retain the rotatable member within the opening of the base member.

In another embodiment, a fluid flow control system is provided. The system can include a stator and a rotor. The stator can have a first set of at least two coupling members configured for attachment to tubing members of a fluid user system and a second set of at least two coupling members configured for attachment to tubing members of an external fluid system. The rotor can include at least two passageways and can be moveable to define two different fluid flow configurations. The first fluid flow configuration can comprise a user circuit in which fluid can flow through the first set of coupling members and the second fluid flow configuration can comprise a fill/flush circuit which allows fluid to flow through both the first and second set of coupling members.

In specific implementations, the rotor can be configured to be rotated about 90 degrees to change the fluid flow configuration of the system from the first fluid flow configuration to the second fluid flow configuration.

In another embodiment, a method for changing fluid in a cooling system is provided. The method can include providing a base member having a plurality of ports, the plurality of ports including a first user port, a second user port, a first external port, and a second external port. The first and second user ports can be coupled to a cooling system. A rotatable member having a first passageway extending therethrough can also be provided. The rotatable member can be configured to be received in the base member opening such that the first and second user ports are in fluid communication with one another via the first passageway. An external fluid connection device can be coupled to the first and second external ports. The rotatable member can be rotated so that the first passageway of the rotatable member is aligned with the first user port and the first external port. Fluid can be removed from the cooling system through the first external port.

In other specific implementations, the rotatable member can include a second passageway and the act of rotating the rotatable member can cause the second passageway to be aligned with the second user port and the second external port. Fluid can be added to the cooling system through the second external port. If desired, the act of rotating the rotatable member can include rotating the rotatable member about 90 degrees. Also, if desired, the act of coupling the external fluid connection device can include connecting quick-release tubing components to the first and second external ports. The external fluid connection device preferably comprises a fluid reservoir and a pump.

In another embodiment disclosed, a coolant fill and flush device is provided. The device comprises a rotary directional flow control valve with a base member and a rotatable member coaxially disposed and having substantially parallel opposing end surfaces adapted for relative sliding engagement as the rotatable member is rotated relative to the base member about a common axis. A plurality of glands can be provided between the rotatable member and base member to receive sealing members such as o-rings. A plurality of ports in the base member can be adapted to be connected to a source of pressure fluid, an external reservoir, and a fluid user reservoir. A plurality of passages can be provided in the rotatable member. The passageways are configured to register with one or more base member ports when the rotatable member is rotated relative to the base member. The ports can include a first set of two external (secondary) ports and a second set of two user (primary) ports. The rotatable member can be movable to connect the first set of ports to one another (recirculation mode) or to connect the second set of ports to the first set of ports (fill/flush mode). A quick disconnect implement unit or stop valve can be attached to the base member at the first set of ports.

The foregoing and other objects, features, and advantages of the disclosed embodiments will become more apparent from the following detailed description, which proceeds with reference to the accompanying figures.

### BRIEF DESCRIPTION OF THE DRAWINGS

FIG. 1 is an isometric view of a rotary directional flow control device.

FIG. 2A is a plan view and FIG. 2B is a cross-sectional view of the device of FIG. 2A, taken along the line A-A.

FIG. 3 is a flow diagram of a flush and fill system that can be used with the device of FIG. 1, shown in recirculation mode with passages 8, 9 being generally parallel to ports 12, 13 14, and 15.

FIG. 4 is a flow diagram of the flush and fill system of FIG. 3, shown in fill/flush mode with passages 8, 9 being generally perpendicular to ports 12, 13, 14, and 15.

FIG. 5 is an isometric view of a rotary directional flow control device.

FIG. 6 is an isometric view of a rotary directional flow control device.

FIG. 7 is a front isometric exploded view of a rotary directional flow control device.

FIG. 8 is a rear isometric exploded view of a rotary directional flow control device.

FIGS. 9A and 9B are top and bottom isometric exploded views of a rotary directional flow control device.

FIG. 10 is an isometric view of a base member and a rotatable member of a rotary directional flow control device.

FIG. 11A is a top view of a rotary directional flow control device in a fill mode.

FIG. 11B is a cross-sectional view of the device of FIG. 11A, taken along line E-E.

FIG. 11C is a cross-sectional view of the device of FIG. 11B, taken along line M-M.

FIG. 12A is a top view of a rotary directional flow control device in a recirculation mode.

FIG. 12B is a cross-sectional view of the device of FIG. 12A, taken along line F-F.

FIG. 12C is a cross-sectional view of the device of FIG. 12B, taken along line N-N.

FIG. 13A is a side view of a rotary directional flow control device in a fill mode, shown with the rotatable member removed for clarity.

FIG. 13B is a side view of a rotatable member for use with the device of FIG. 13A.

FIG. 13C is a cross-sectional view of the device of FIG. 13A, taken along line J-J.

FIG. 13D is a cross-sectional view of the device of FIG. 13A, taken along line L-L.

FIG. 14A is a side view of a rotary directional flow control device in a recirculation mode, shown with the rotatable member removed for clarity.

FIG. 14B is a side view of a rotatable member for use with the device of FIG. 14A.

FIG. 14C is a cross-sectional view of the device of FIG. 13A, taken along line H-H.

FIG. 14D is a cross-sectional view of the device of FIG. 13A, taken along line I-I.

### DETAILED DESCRIPTION

The following description is exemplary in nature and is not intended to limit the scope, applicability, or configuration of the disclosed embodiments in any way. Various changes to the described embodiment may be made in the function and arrangement of the elements described herein without departing from the scope of the disclosure.

As used in this application and in the claims, the singular forms “a,” “an,” and “the” include the plural forms unless the context clearly dictates otherwise. Additionally, the term “includes” means “comprises.”

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

The present disclosure relates to filling and flushing of a cooling system, such as a cooling system for an automotive engine, that does not allow the installation of a convenient filling location such as a radiator cap or venting locations to remove trapped air from the cooling system.

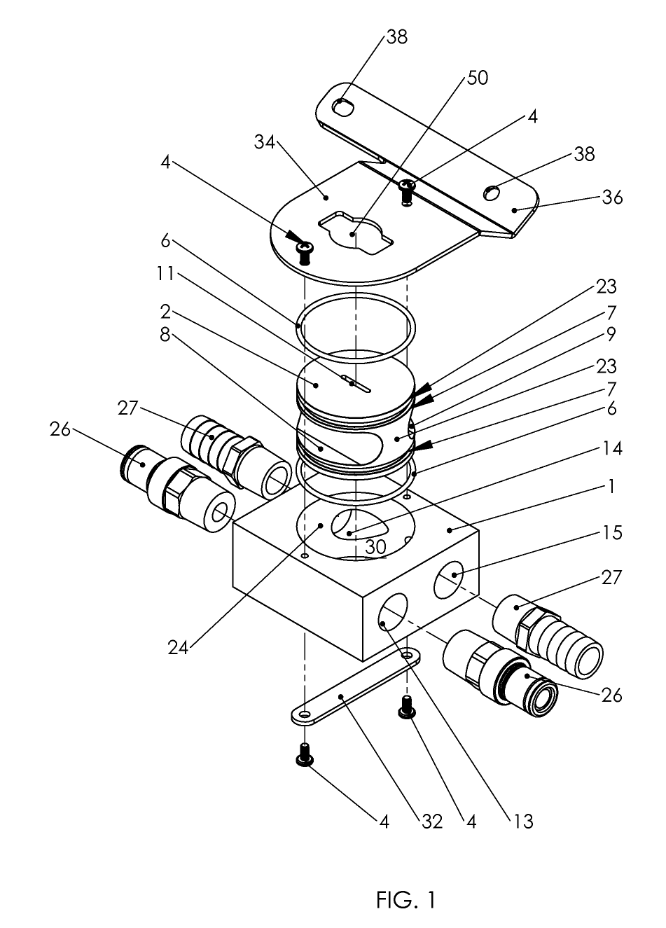

FIG. 1 is an isometric, exploded view of an embodiment of a rotary directional flow control device. The rotary directional flow control device comprises a base member (e.g., a stator) 1 that has a plurality of passageways (e.g., ports) 12, 13, 14, 15 extending through at least a portion of the base member 1. Ports 12, 13, 14, 15 are preferably generally cylindrical in cross section; however, other shapes and configurations are possible. Base member 1 has a generally cylindrical opening 30 that is configured to receive a rotatable member (e.g., a rotor) 2 within opening 30.

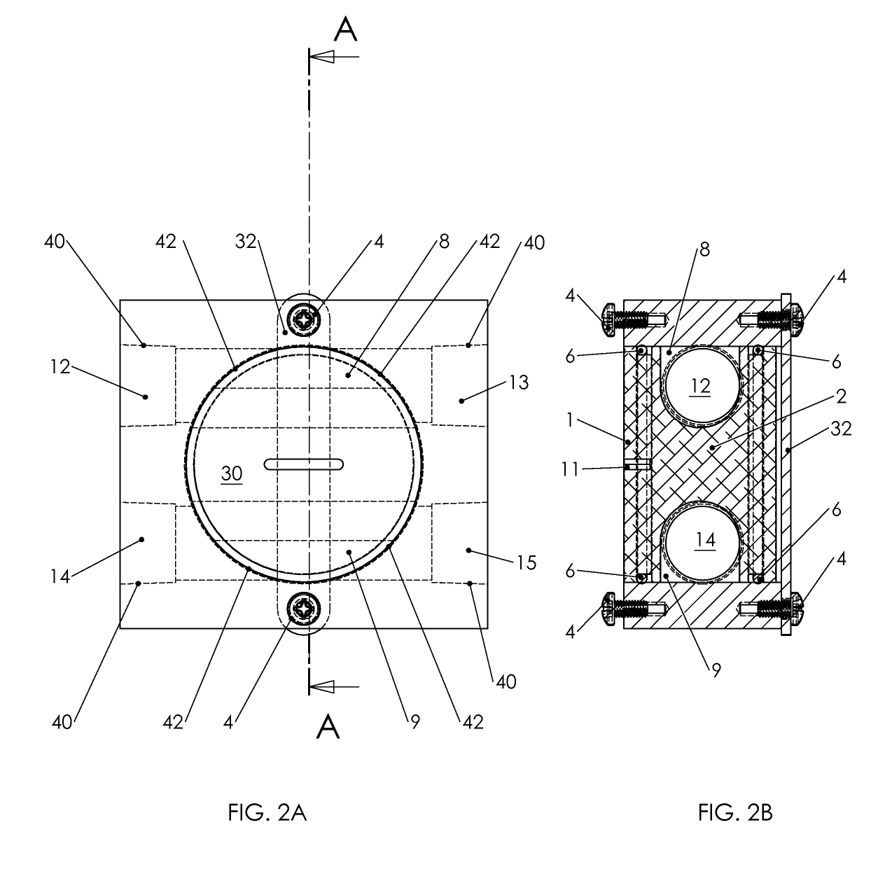

In the embodiment shown in FIG. 1, the ports are configured so that each port is axially aligned with a second port that is located across opening 30 of base member 1. As shown in FIGS. 1 and 2, the ports are spaced apart and separated from one another (e.g., diametrically offset) by the central opening 30. As best seen in FIG. 2, ports 12 and 13 are generally axially aligned with each other and ports 14 and 15 are generally axially aligned with each other.

As discussed in more detail below, each of the ports 12, 13, 14, 15 preferably has a coupling member (e.g., fitting) engaged or associated with it. Coupling members 26, 27 are in fluid contact with the ports 12, 13, 14, and 15 and extend outwardly from base member 1 to provide an attachment location on the outside of base member 1. Coupling members 26, 27 are configured to be coupled to connecting elements of the cooling system (e.g., tubing, hosing, etc.).

Preferably, at least two of the coupling members comprise quick-release coupling members. For example, as shown in FIG. 1, coupling members 26 extend from ports 12, 13 and are desirably quick-release coupling members. Although quick-release coupling members 26 can be associated with any of the ports, ports 14, 15 are preferably associated with coupling members of a more fixed nature, such as the barbed couplings shown in FIG. 1. If the coupling members 26, 27 are not quick release, they can include any mechanism configured to secure or hold a tubing component (or other connecting element) to the coupling member 27, including, for example, ridged, barbed, or threaded portions.

As noted above, rotatable member 2 is configured to be received within opening 30. Rotatable member 2 can be generally cylindrical with two grooves or passageways 8, 9 extending through rotatable member 2. Passageways 8, 9 can comprise arcuate notches or grooves in the generally cylindrical side face of rotatable member 2 (as shown in FIG. 1). The notches or grooves are preferably formed on opposing side faces so that they are located at the same height and at the same distance from the end face of the rotatable member.

When rotatable member 2 is positioned with the base member 1, passageways 8, 9 and a portion of an inner face 24 of base member 1 collectively define a pathway for fluid to travel between ports 12, 13, 14, and 15 (as discussed in more detail below). Thus, such passageways can be considered to be at least partially “open” passageways in that they are not fully enclosed within the rotatable member 2. Alternatively, the passageways can be internal to rotatable member 2 (i.e., formed by the structure of the rotatable member alone), as shown in other embodiments herein.

Preferably, rotatable member 2 is secured within opening 30 of base member 1 in a fluid-tight manner. Accordingly, rotatable member 2 preferably has one or more grooves (e.g., annular groove or gland) 7 at one or more locations above and/or below passageways 8, 9 for receiving a sealing member 6. Sealing member 6 can be an o-ring or other suitable sealing element configured to surround a portion of the body of rotatable member 2 to prevent or restrict fluid leakage between rotatable member 2 and base member 1. To secure rotatable member 2 within opening 30, end caps or other such securing elements can be positioned above and below rotatable member 2. For example, as shown in FIG. 1, a bottom bracket 32 can be positioned below rotatable member and secured to base member 1 using suitable fasteners 4 (e.g., screws, bolts, nuts, pins, rivets, stakes). Similarly, a top bracket 34 can be positioned above rotatable member and secured to base member 1 using suitable fasteners 4. Alternatively, as discussed in more detail below, rotatable member 2 can be secured, at least in part, by a structural element integrally formed with base member 1.

Base member 1 comprises an inner face 24 that faces (and at least partially defines) opening 30. When rotatable member 2 is positioned within opening 30, an outer face 23 of rotatable member 2 faces the inner face 24 of base member 1. Preferably, the outer face 23 and inner face 24 form a substantially fluid tight fit, so that in the various configurations described herein, when those two faces are in a configuration or position where they oppose each other, fluid is restricted from passing between the outer face 23 and inner face 24.

If desired, a mounting member can extend from a structure of the flow control device to allow the device to be mounted to an external structural member, such as a portion of the structure containing the coolant system (e.g., a structural member of an automobile). FIG. 1 illustrates a mounting member 36 that extends from the top bracket 34. Mounting member 36 comprises openings 38 for mounting the flow control device to an external structural member. It should be understood that the location, size, and shape of the mounting member can vary depending on the application in which the flow control device will be used.

FIG. 2A is a plan view and FIG. 2B is a cross-sectional view of the valve of FIG. 2, taken along the line A-A. As shown in FIG. 2A, ports 12, 13, 14, 15 can comprise a portion 40 with a wider diameter to facilitate the reception of a coupling member 26, 27. In addition, an inner portion of base member 1 defines the exits of ports 12, 13, 14, 15 into opening 30 and preferably has a curved section 42 that, in turn, at least partially defines the generally circular opening 30.

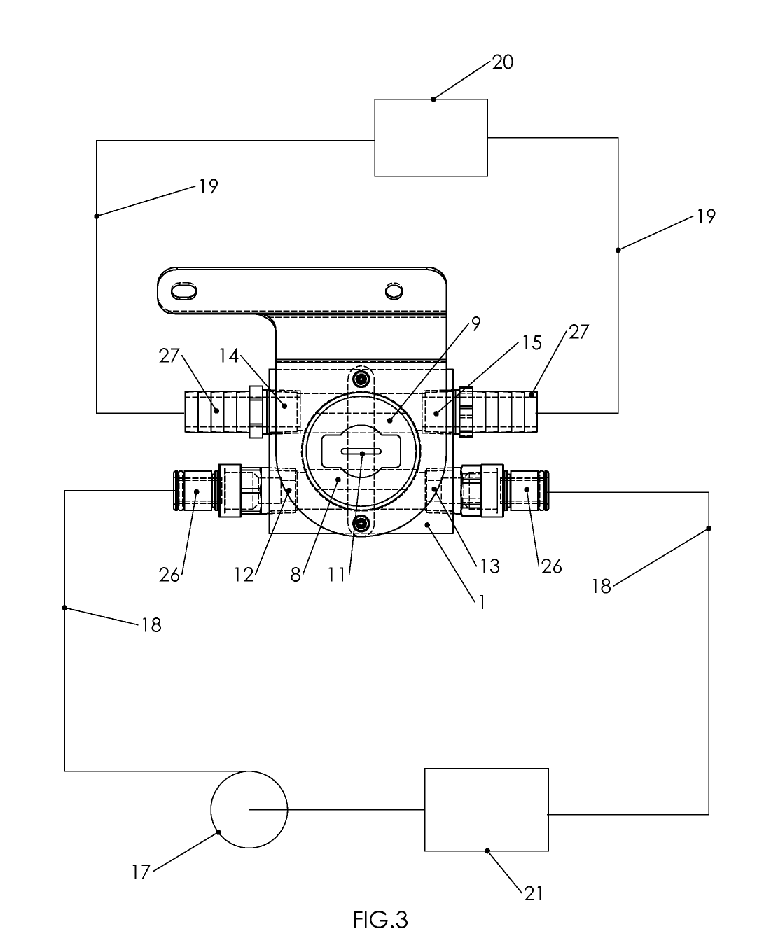

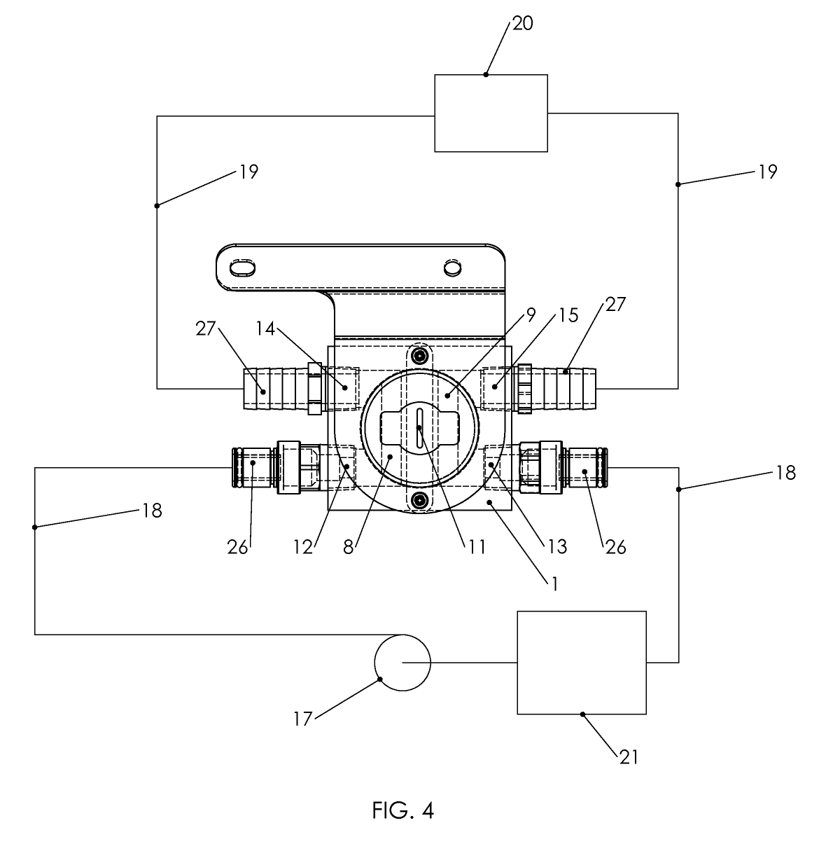

FIGS. 3 and 4 show two different flow diagrams that can be achieved using a flow control device as described herein. FIG. 3 shows a recirculation mode and FIG. 4 shows a fill/flush mode.

As described above, the flow control devices described herein can be coupled to a cooling system (fluid user) of an engine or other similar system. To achieve recirculation within the cooling system, coupling members 27 (which are associated with ports 14, 15) can be attached to a fluid reservoir 20 (e.g., coolant reservoir) via tubing components (e.g., tubing, hosing) 19 or other connecting structures capable of conveying fluid from the fluid reservoir to the flow control device and back to the fluid reservoir. Fluid reservoir 20 can be an internal system reservoir that supplies fluid (e.g., coolant) to the cooling system.

To cool the system, the fluid (coolant) can flow in a loop (e.g., recirculate) through the cooling system between the fluid reservoir 20 and ports 14, 15 of the flow control device. This circuit can be referred to as the user or system circuit. Thus, port 14 (also called “first system port” or “first user port”) and port 15 (also called “second system port” or “second user port”) are configured to allow fluid recirculation through the system.

Ports 12 and 13 are configured to permit fluid to flow out of the cooling system (flush) and permit unused fluid to flow into the cooling system (fill) to refill the user reservoir 20. Thus, port 12 can be referred to as “first external port” or “first flush/fill port,” and port 13 can be referred to as “second external port” or “second flush/fill port.” Ports 12 and 13 are “external” in that they allow connection to an external device for filling or flushing fluid into or out of the user or system circuit. Alternatively, for convenience, the user/system ports can be referred to “primary ports” and the external/flush-fill ports as “secondary ports.”

When the system is to be flushed and/or filled, rotatable member 2 is moved from a first position which allows for a first flow configuration (recirculation) to a second position which allows for a second fluid flow configuration (fill/flush). Coupling members 26 (e.g., quick-release coupling members associated with ports 12, 13) can be connected to an external fluid reservoir 21 via tubing components (e.g., tubing, hosing) 18 or other structures capable of conveying fluid from the external fluid reservoir 21 to the flow control device. A pump 17 can be used to provide sufficient pressure to cause the fluid to flow to and from the external fluid reservoir 21 as desired.

In FIG. 3, rotatable member 2 is in the first position. In this position or orientation, passageway 8 is aligned and in fluid communication with ports 12 and 13, and passageway 9 is aligned and in fluid communication with ports 14 and 15. Thus, as shown in FIG. 3, the first flow configuration of the fluid flow control device defines two separate fluid flow circuits. In the first fluid circuit (the system circuit), fluid can flow between ports 14, 15 and fluid reservoir 20, and in the second fluid circuit (the external circuit), fluid can flow between ports 12, 13 and external fluid reservoir 21. The quick-release coupling members preferably have a stop valve that prevents fluid from passing through the coupling member when no tubing components or other such connecting elements are connected to the coupling member. Accordingly, if there are no elements connected to the coupling members 26, no fluid will flow between the ports associated with the quick-release coupling members (e.g., ports 12, 13 in FIG. 3). Instead, those ports will simply be closed or dead-ended.

As shown in FIG. 4, the rotatable member 2 can be moved (rotated) to a second position in which a second flow configuration is achieved. In the second configuration, rotatable member 2 is rotated 90 degrees so that passageway 8 is in fluid communication with ports 12 and 14, and passageway 9 is in fluid communication with ports 13 and 15. Thus, the flow control device creates a fill/flush fluid circuit where fluid can flow from reservoir 20 to port 15 to port 13 to reservoir 21 to port 12, to port 14 and back to reservoir 20 (or the reverse of that circuit, if desired). Pump 17 can be used to force the fluid to flow through the system in the desired direction with the desired amount of pressure. By pumping fluid from reservoir 20 to external reservoir 21, fluid can be flushed from the system. Similarly, by pumping fluid from external reservoir 21 to reservoir 20, the cooling system can be filled.

It should be understood that various configurations can be used to allow the fluid to be flushed from the cooling system prior to filling the cooling system. For example, a portion of the external circuit can be discontinuous, with a first portion configured to remove fluid from the system and a second portion configured to fill the system.

The fluid circuit is preferably filled using a pump with a large flow capacity so that fluid flow through the second flow configuration entrains the trapped air in the fluid and removes it from the cooling system. The filling system also preferably utilizes clear or transparent tubing components (e.g., tubing, hoses, etc.) to allow the operator to observe when the fill fluid has little or no aerated fluid in the return line. After the fill/flush operation is completed, rotatable member 2 can be returned to the first position (FIG. 3), once again isolating of the user circuit from the external circuit and the outside environment. The quick-release coupling members 26 allow the external fill and discharge hoses/lines to be readily removed once the rotatable member 2 is returned to the first position (FIG. 3).

Rotatable member 2 can be moved from the first position (orientation) to the second position (orientation) in a variety of ways. For example, as shown in FIGS. 1 and 2, rotatable member 2 can have an actuating member formed in a surface of rotatable member 2. The actuating member can be a male (e.g., protruding) or female (e.g., recessed) member. For example, a notch or recess 11 can be provided to receive a tool (e.g., a screwdriver). The tool can be inserted into recess 11 and turned 90 degrees to move rotatable member 2 from the first position (FIG. 3) to the second position (FIG. 4). Instead of a recess, rotatable member 2 can have an extending portion that extends from a top or bottom surface of rotatable member 2. The extending portion can be manually rotated by a user (with or without a tool). Thus, an extending portion can serve as an actuating lever adapted to rotate the rotatable member between the various desired positions.

In addition, FIG. 1 illustrates an aperture 50 in the top bracket 34. Aperture 50 can be sized so that a tool can pass through aperture 50 into recess 11. In addition, aperture 50 can be shaped so that the tool can be received and withdrawn in only two positions, with those two positions corresponding to the two positions (described above) of rotatable member 2.

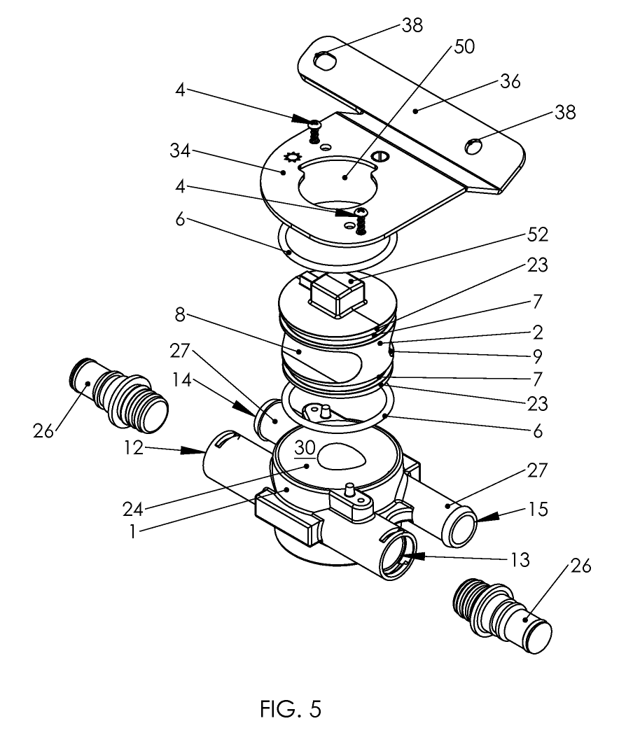

FIG. 5 illustrates another embodiment of a fluid flow control device. To the extent that the fluid flow control device of FIG. 5 is similar to the fluid flow control device of FIG. 1, the same element numbers are used to describe the parts of the fluid flow control device. The structure, function, and operation of these common elements will not be further described except to the extent that any differences between the embodiments cannot be readily discerned from the figures.

Like the fluid flow control device shown in FIG. 1, the device of FIG. 5 has a plurality of ports 12, 13, 14, and 15 which are axially aligned in pairs. Base member 1 of FIG. 5 differs from base member 1 of FIG. 1 in that the structure of FIG. 5 is more streamlined. Rather than having a base member shaped like a block with ports extending therethrough, base member 1 of FIG. 5 can be manufactured using less materials. For example, ports 13, 15 and ports 12, 14 are spaced apart from one another with gaps between them, respectively. These gaps allow for a reduction in materials and, since the device is generally smaller in size (e.g., both in volume and cross-sectional profile), can allow the device to be positioned more easily within a cooling system.

In addition, instead of a recessed member 11, the device of FIG. 5 has an extending portion (extrusion) 52 which extends from a top surface of rotatable member 2. Extending portion 52 is configured to be grasped and rotated in order to move rotatable member 2 from the first position to the second position. Extending portion 52 can be rotated manually using a tool, such as an end wrench, ratchet, an adjustable wrench, or other similar grasping tool. As described above, aperture 50 can be configured to restriction movement of the rotatable member. Preferably, rotatable member 2 is restricted from moving into orientations beyond the first position and second positions. Thus, aperture 50 can be configured to restrict movement of rotatable member 2 beyond the 90 degrees required to move it between the first position and the second position.

Another difference between the fluid flow control devices of FIG. 5 and FIG. 1 is that the device of FIG. 5 does not have a removable bottom bracket. Instead, base member 1 has a solid base plate (formed integral with base member 1) that holds rotatable member 2 within opening 30.

FIGS. 6-8 illustrate another embodiment of a fluid flow control device. To the extent that the fluid flow control device of FIGS. 6-8 is similar to the fluid flow control device of FIG. 1, the same element numbers are used to describe the parts of the fluid flow control device. The structure, function, and operation of these common elements will not be further described except to the extent that any differences between the embodiments cannot be readily discerned from the figures.

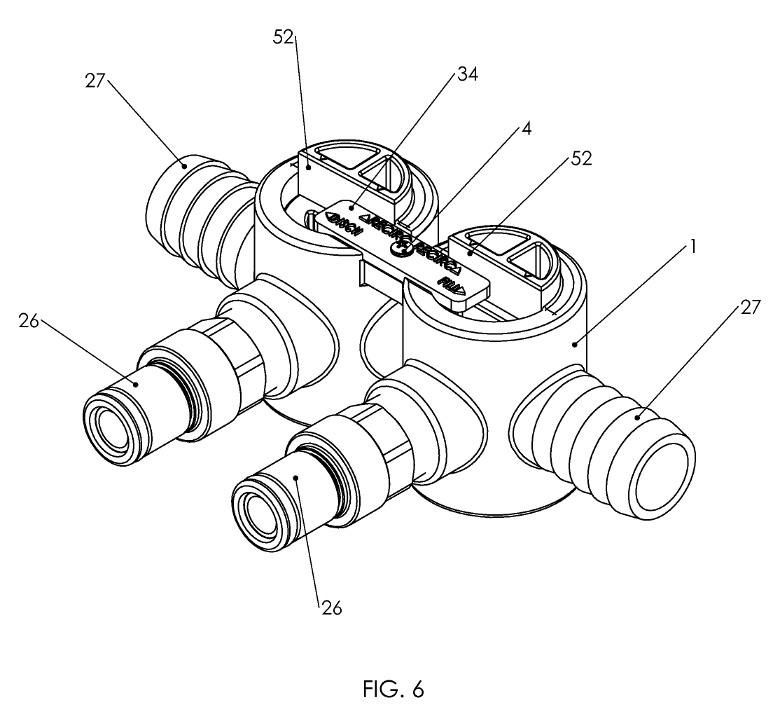

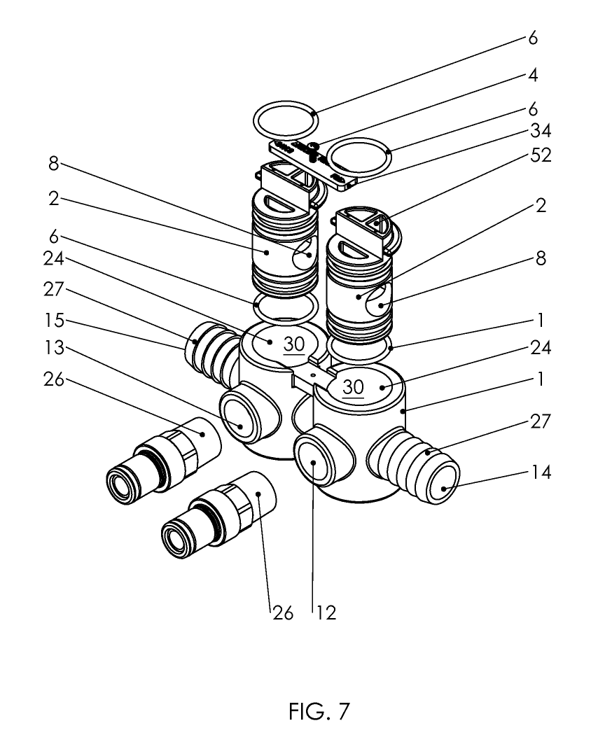

Referring to FIG. 7, the fluid flow control device comprises a base member 1 with two openings 30 for receiving two rotatable members 2. First user port 15 and second user port 16 are positioned so that they are in-line with one another. Passageways 8 are formed in the shape of a “T”, with a first opening portion 60 extending entirely through the rotatable member 2 (i.e., from one side of the rotatable member to the other) and a second opening portion 62 extending at an angle from the first opening portion. Thus, the passageway can comprise straight sections extending offset and perpendicular to the axis of rotation of the rotatable member and straight sections extending generally parallel to the axis of rotation of the base member.

Desirably, the second opening portion is configured to extend from the first opening portion at about 90 degrees as best seen in FIG. 8. When the two rotatable members are each held in a first position (as shown in the exploded view of FIG. 7), ports 14 and 15 are in fluid connection with one another via the first opening portions 60 of passageways 8. As shown in FIG. 8, openings 30 are spaced apart from one another and are preferably connected via a generally hollow bridge member 64. Bridge member 64 permits fluid to pass between the openings 30 when the rotatable members 2 are configured to provide an open passageway between the two openings 30.

FIGS. 7 and 8 illustrate the rotatable members 2 in a first position (although in an exploded view) that allows flow to pass between user ports 14 and 15. This first position allows for the recirculation of fluid in the cooling system. Even if an external system is connected to external ports 12 and 13, no circulation of fluid is possible between ports 12 and 13 when the two rotatable members 2 are in their respective first position. That is, in the first position (FIGS. 7 and 8), the passageways 8 of rotatable members 2 are not aligned or in fluid connection with ports 12 and 13.

To change the system configuration from a recirculation mode to a fill/flush mode, the rotatable members 2 are moved to a second position. In the second position, one of the rotatable members 2 (the one adjacent to port 14) is rotated 90 degrees clockwise from the orientation shown in FIGS. 6-8, and the other one of the rotatable members 2 (the one adjacent to port 15) is rotated 90 degrees counter-clockwise from the orientation shown in FIGS. 6-8. When the rotatable members are moved to the second position, the first passageway 8 opens a fluid connection between ports 12 and 14, and the second passageway 8 opens a fluid connection between ports 13 and 15. At the same time, the fluid connection between ports 14 and 15 is closed. Thus, in the fill/flush mode, a circuit is provided (similar to that discussed above with respect to FIG. 4) whereby fluid can be removed from the user system (e.g., internal reservoir) and/or new fluid can be added to the user system from an external source (e.g., external reservoir).

Referring to FIG. 6, extending portion 52 is configured so that it is movable (e.g., rotatable) to move the rotatable members 2 from their respective first positions to their respective second positions. Also, extending portions 52 is preferably configured to restrict movement of rotatable members 2 other than between the desired two configurations. For example, extending portion 52 is only rotatable about 90 degrees in view of the shape and position of top bracket 34.

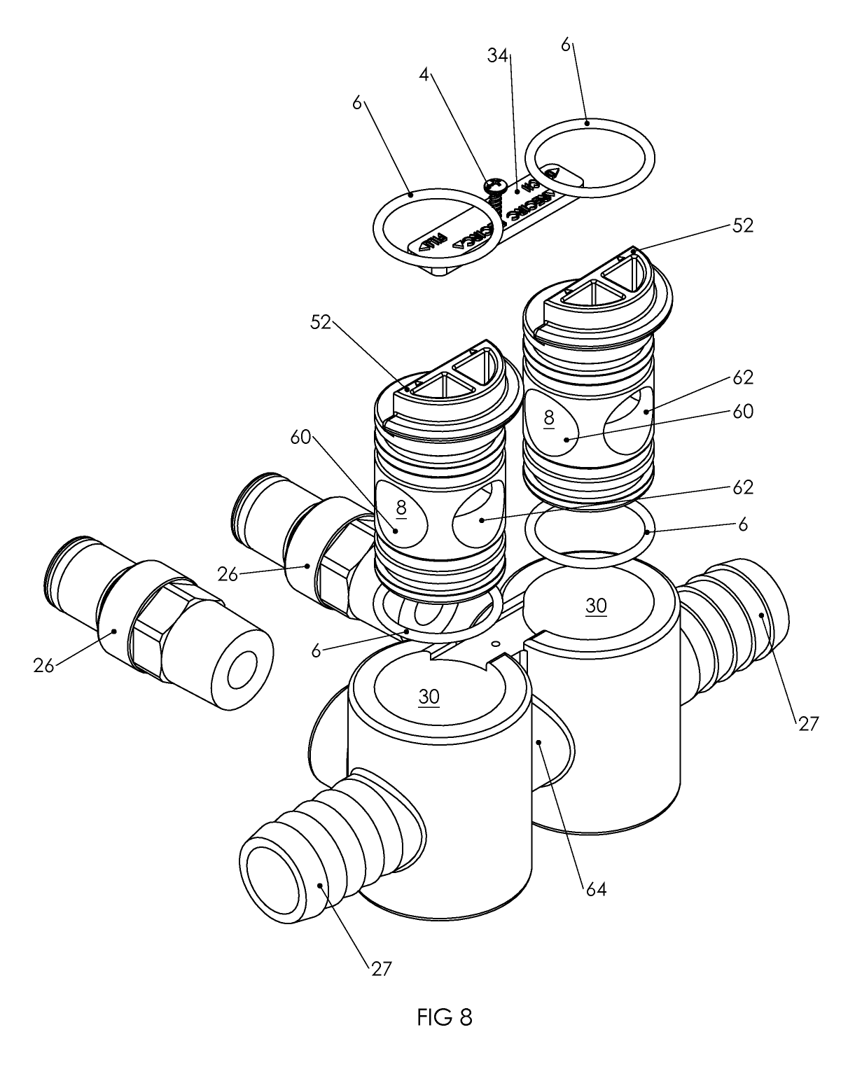

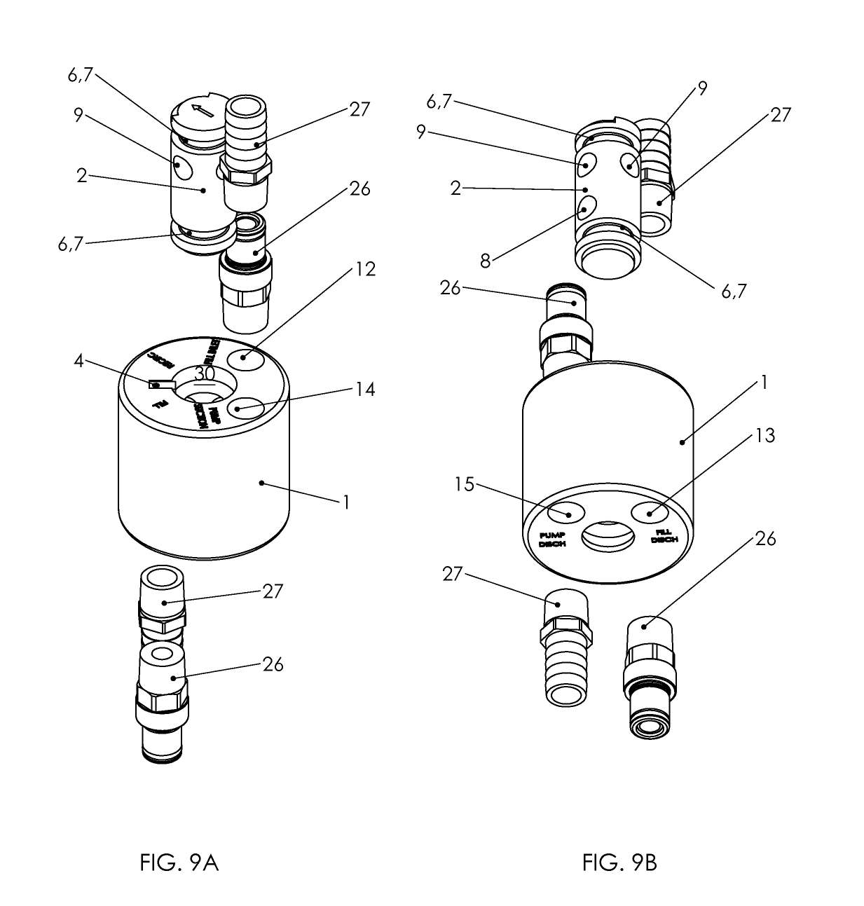

FIGS. 9-14 illustrate another embodiment of a fluid flow control device. To the extent that the fluid flow control device of FIGS. 9-14 is similar to the fluid flow control device of FIG. 1, the same element numbers are used to describe the parts of the fluid flow control device. The structure, function, and operation of these common elements will not be further described except to the extent that any differences between the embodiments cannot be readily discerned from the figures.

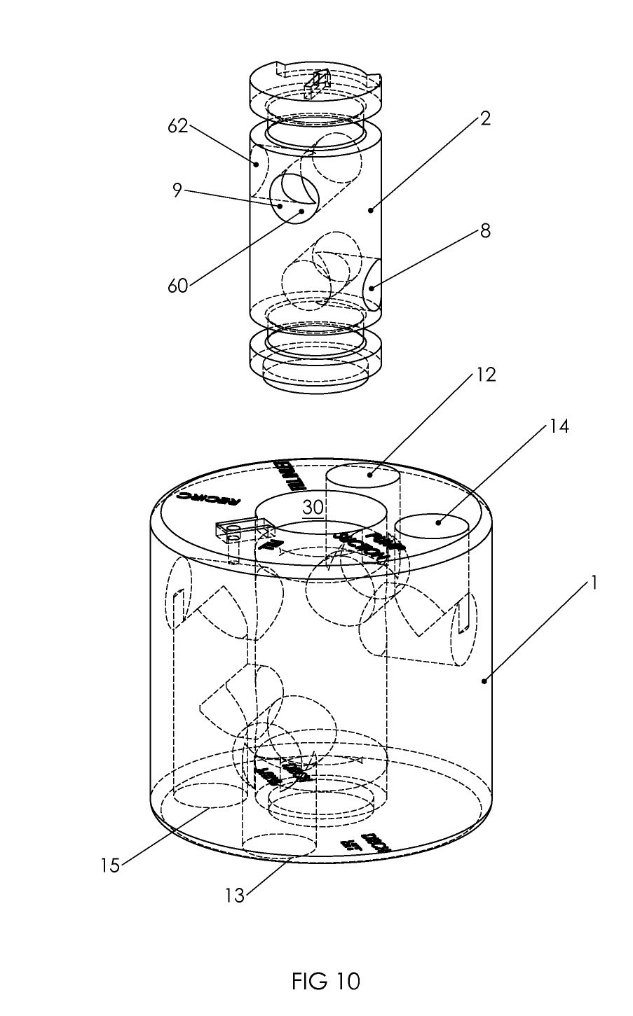

Referring to FIGS. 9A and 9B, a base member 1 is configured with an opening 30 for receiving a rotatable member 2. Rotatable member 2 comprises two passageways 8 and 9. As best seen in FIG. 10, the first passageway 8 has two openings in the face of the rotatable member 2. The first passageway 8 is preferably generally L shaped, with the two openings in face of the rotatable member being about 90 degrees apart from one another. The second passageway 9 comprises three openings in the face of the rotatable member 2. Preferably, the second passageway 9 is generally T shaped, with a first opening portion 60 extending entirely through the rotatable member 2 (i.e., from one side of the rotatable member to the other) and a second opening portion 62 extending at an angle from the first opening portion. Desirably, the second opening portion is configured to extend from the first opening portion at about 90 degrees, as best seen in FIG. 10.

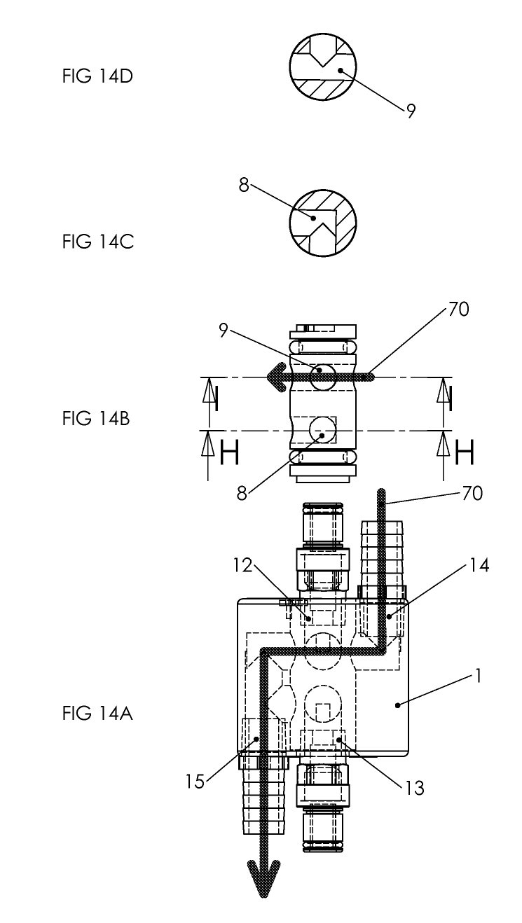

The rotatable member 2 is movable between a first position (recirculation) and a second position (fill/flush). FIGS. 12A-12C and 14A-14D illustrate the rotatable member 2 in the first position whereby fluid in the system can be circulated between user ports 14, 15. As best seen in FIGS. 12B and 14A, when the rotatable member 2 is in the first position (e.g., in the recirculation mode), fluid can flow between user ports 14 and 15, as represented by the arrow 70. Ports 12, 13, however, are not in fluid connection with each other (or with any other ports) when the rotatable member 2 is in the first position.

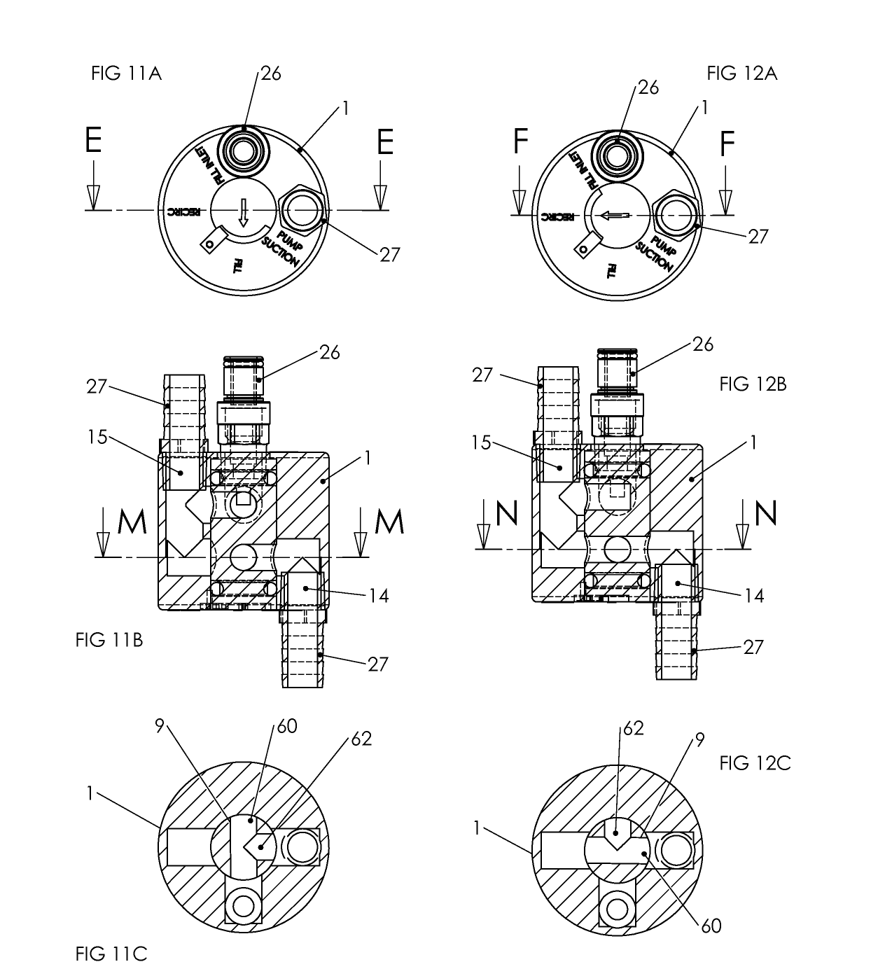

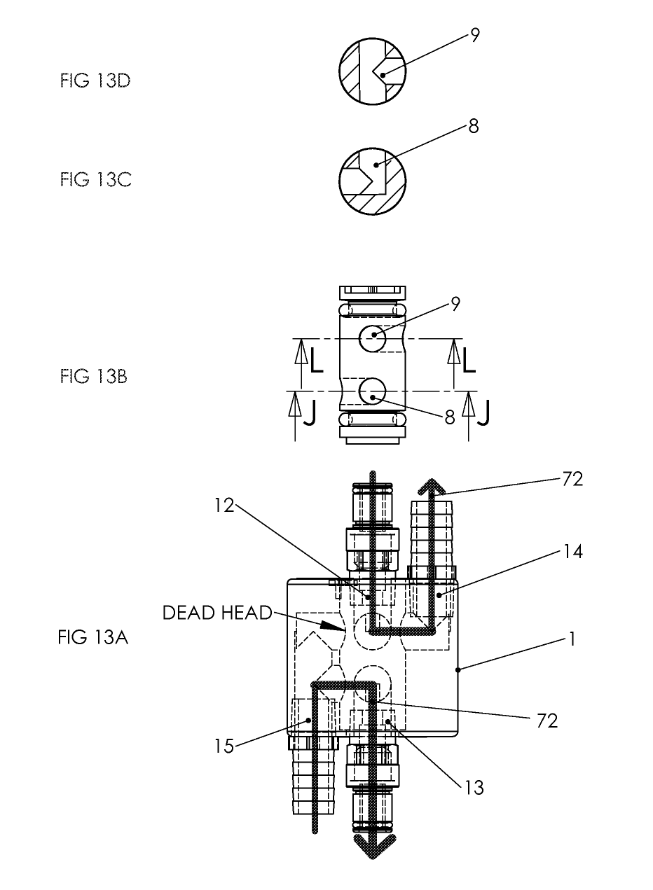

FIGS. 11A-11C and 13A-13 illustrate the rotatable member in the second position. Once the rotatable member 2 is rotated to the second position, fluid can flow between ports 12 and 14, and between ports 13 and 15 as represented by the arrows 72. Thus, in fill/flush mode, the fluid can be delivered through port 12, through port 14, through the internal reservoir (e.g., as shown in FIG. 4), through port 15, and through port 13, and out to an external reservoir and/or pump (e.g., as shown in FIG. 4), and back into port 12.

It should be understood that the devices described herein can be constructed of various materials, including, for example, various plastics or metals, such as aluminum, metal matrix, titanium, brass, zinc, and/or combinations thereof.

In view of the many possible embodiments to which the principles of the disclosed embodiments may be applied, it should be recognized that the illustrated embodiments are only preferred examples and should not be taken as limiting the scope of protection. Rather, the scope of the protection is defined by the following claims. I therefore claim all that comes within the scope and spirit of these claims.

I claim:

1. A fluid flow control device configured to facilitate the addition and removal of fluid to and from a cooling system, the device comprising:
a base member having an opening and plurality of ports capable of being in fluid communication with the opening, the plurality of ports including at least two user ports and two external ports; and
a rotatable member having at least one passageway extending therethrough, the rotatable member being configured to be received in the opening and being movable within the opening between a first position and a second position,
wherein, when the rotatable member is in the first position, the at least two user ports are in fluid communication with one another via the at least one passageway of the rotatable member and the at least two user ports are not in fluid communication with the external ports, and
wherein, when the rotatable member is in the second position, the at least two user ports and the at least two external ports are in fluid communication with one another via the at least one passageway of the rotatable member.

2. The device of claim 1, wherein each of the at least two user ports and each of the at least two external ports have a coupling member associated therewith, the coupling members facilitating the fluid connection of the user ports and external ports with tubing components.

3. The device of claim 2, wherein the coupling members associated with the external ports comprise quick-release coupling members that restrict fluid flow through the coupling members when no tubing components are connected to the quick-release coupling members.

4. The device of claim 1, wherein the at least two user ports are axially aligned with one another.

5. The device of claim 1, wherein the at least two external ports are axially aligned with one another.

6. The device of claim 1, wherein the at least two external ports are oriented parallel to one another.

7. The device of claim 1, wherein the rotatable member comprises an actuating member for rotating the rotatable member between the first position and the second position.

8. The device of claim 7, wherein the actuating member comprises a recessed portion of the rotatable member.

9. The device of claim 7, wherein the actuating member comprises an extending portion.

10. The device of claim 7, further comprising a restricting member, the restricting member allowing rotation of the rotatable member between the first and second positions and restricting rotation of the rotatable member beyond those positions.

11. The device of claim 1, wherein the rotatable member comprises two passageways extending through the rotatable member.

12. The device of claim 1, wherein the passageways comprise grooves on opposing sides of the rotatable member.

13. The device of claim 1, wherein the at least one passageway is generally T-shaped, with a first opening portion extending through the rotatable member and a second opening portion extending off of the first opening portion at an angle.

14. The device of claim 13, further comprising a second passageway in the rotatable member, the second passageway being generally L-shaped.

15. The device of claim 1, wherein the base member comprises two openings, with each opening being configured to receive a rotatable member and each opening capable of being in fluid communication with one of the user ports and one of the external ports.

16. The device of claim 1, wherein the two user ports extend from opposite faces of the base member and the two external ports extend from opposite faces of the base member.

17. The device of claim 1, further comprising a mounting member extending from the device, the mounting member having at least one aperture for securing the device to another structural element.

18. The device of claim 1, further comprising a bracket secured to the base member to retain the rotatable member within the opening of the base member.

19. A fluid flow control system, comprising:
a stator having a first set of at least two coupling members configured for attachment to tubing members of a fluid user system and a second set of at least two coupling members configured for attachment to tubing members of an external fluid system; and
a rotor comprising at least two passageways and being moveable to define two different fluid flow configurations,
wherein the first fluid flow configuration comprises a user circuit in which fluid can flow through the first set of coupling members and the second fluid flow configuration comprises a fill/flush circuit which allows fluid to flow through both the first and second set of coupling members.

20. The system of claim 19, wherein the rotor is configured to be rotated about 90 degrees to change the fluid flow configuration of the system from the first fluid flow configuration to the second fluid flow configuration.

21. A method for changing fluid in a cooling system, the method comprising:
providing a base member having a plurality of ports, the plurality of ports including a first user port, a second user port, a first external port, and a second external port, with the first and second user ports being coupled to a cooling system;
providing a rotatable member having a first passageway extending therethrough, the rotatable member being configured to be received in the base member opening such that the first and second user ports are in fluid communication with one another via the first passageway;
coupling an external fluid connection device to the first and second external ports;
rotating the rotatable member so that the first passageway of the rotatable member is aligned with the first user port and the first external port; and
removing fluid from the cooling system through the first external port.

22. The method of claim 21, wherein the rotatable member further comprises a second passageway, the act of rotating the rotatable member causing the second passageway to be aligned with the second user port and the second external port, the method further comprising:
adding fluid to the cooling system through the second external port.

23. The method of claim 21, wherein the act of rotating the rotatable member comprises rotating the rotatable member about 90 degrees.

24. The method of claim 21, wherein the act of coupling the external fluid connection device comprises connecting quick-release tubing components to the first and second external ports.

25. The method of claim 21, wherein the external fluid connection device comprises a fluid reservoir and a pump.
